(19) United States
(12) Patent Application Publication
(10) Pub. No.: US 2026/0093296 A1
(43) Pub. Date: Apr. 2, 2026

(54) DISPLAY APPARATUS

(71) Applicant: SAMSUNG ELECTRONICS CO., LTD., Suwon-si (KR)

(72) Inventor: Gibaek KIM, Suwon-si (KR)

(73) Assignee: SAMSUNG ELECTRONICS CO., LTD., Suwon-si (KR)

(21) Appl. No.: 19/350,181

(22) Filed: Oct. 6, 2025

Related U.S. Application Data
(63) Continuation of application No. PCT/KR2025/013872, filed on Sep. 8, 2025.

(30) Foreign Application Priority Data
Sep. 28, 2024 (KR) 10-2024-0132272

(51) Int. Cl. G06F 1/18; F16M 11/04; G06F 1/16

(52) U.S. Cl. CPC G06F 1/181; F16M 11/04; G06F 1/1601

(57) ABSTRACT

A display apparatus configured to be detachably coupled to a stand may be provided and include: a display panel; and a chassis configured to support the display panel, wherein the chassis includes: a rear chassis behind the display panel; a front chassis covering an edge of the display panel on a front side of the rear chassis; a base plate on an inner side of the rear chassis; and a first bead recessed in a front surface of the base plate so as to protrude rearward from the base plate, wherein the first bead includes: a first stand coupling portion including a first insertion hole, the first insertion hole configured to receive at least a portion of the stand in a first direction; and a first extension portion that extends in the first direction from the first stand coupling portion.

### CROSS-REFERENCE TO RELATED APPLICATIONS

This application is a bypass continuation application of International Patent Application No. PCT/KR2025/013872, filed on September 8, 2025, which claims priority to Korean Patent Application No. 10-2024-0132272, filed in the Korean Intellectual Property Office on September 28, 2024, the disclosures of which are herein incorporated by reference in their entireties.

### BACKGROUND

### 1. Field

Some embodiments of the present disclosure relate to a display apparatus including an improved structure.

### 2. Description of Background Art

A display apparatus is a type of output device that converts obtained or stored electrical information into visual information and displays the visual information to a user.

The display apparatus may include a self-luminous display panel, such as an organic light-emitting diode (OLED), or a non-self-luminous display panel, such as a liquid crystal display (LCD).

Additionally, the display apparatus may include a chassis provided to support a display panel, and a rear cover provided to cover a rear side of the chassis.

The display apparatus may be detachably coupled to a stand. When the display apparatus is coupled to the stand, the display apparatus may be supported by the stand.

### SUMMARY

According to some embodiments of the present disclosure, a display apparatus including a chassis formed by injection molding may be provided.

According to some embodiments of the present disclosure, a display apparatus including a chassis having an increased rigidity may be provided.

According to some embodiments of the present disclosure, a display apparatus capable of preventing a display from being bent may be provided.

Additional aspects of the present disclosure will be set forth in part in the description which follows and, in part, will be understood from the description, or may be learned by practice of the present disclosure.

According to some embodiments of the present disclosure, a display apparatus configured to be detachably coupled to a stand is provided and includes: a display panel; and a chassis configured to support the display panel, wherein the chassis includes: a rear chassis behind the display panel; a front chassis covering an edge of the display panel on a front side of the rear chassis; a base plate on an inner side of the rear chassis; and a first bead recessed in a front surface of the base plate so as to protrude rearward from the base plate, wherein the first bead includes: a first stand coupling portion including a first insertion hole, the first insertion hole configured to receive at least a portion of the stand in a first direction; and a first extension portion that extends in the first direction from the first stand coupling portion.

According to some embodiments of the present disclosure, a display assembly including the display apparatus and the stand may be provided.

### BRIEF DESCRIPTION OF DRAWINGS

FIG. 1 is a view illustrating a display apparatus and a stand according to an embodiment.

FIG. 2 is a view illustrating the display apparatus and the stand according to an embodiment.

FIG. 3 is a view illustrating a state in which the display apparatus and the stand are separated according to an embodiment.

FIG. 4 is a view illustrating the state in which the display apparatus and the stand are separated according to an embodiment.

FIG. 5 is an exploded view of a chassis and peripheral components according to an embodiment.

FIG. 6 is an exploded view of the chassis and the peripheral components according to an embodiment.

FIG. 7 is a rear view of the chassis according to an embodiment.

FIG. 8 is an enlarged view of a region C illustrated in FIG. 7.

FIG. 9 is a cross-sectional view of a first bead according to an embodiment.

FIG. 10 is a cross-sectional view of a second bead according to an embodiment.

FIG. 11 is a view illustrating a state in which the chassis and a rear cover are separated according to an embodiment.

FIG. 12 is a view illustrating the state in which the chassis and the rear cover are separated according to an embodiment.

FIG. 13 is an enlarged view of a region D illustrated in FIG. 11.

FIG. 14 is a cross-sectional view taken along a line A-A’ illustrated in FIG. 3.

FIG. 15 is an enlarged view of a region E illustrated in FIG. 14.

FIG. 16 is a cross-sectional view taken along a line B-B’ illustrated in FIG. 3.

FIG. 17 is an enlarged view of a region F illustrated in FIG. 16.

FIG. 18 is an enlarged view of a region G illustrated in FIG. 16.

### DETAILED DESCRIPTION

Example embodiments described in the present disclosure and terminology used in the present disclosure are not intended to limit the present disclosure to the specific example embodiments, but rather the present disclosure should be understood to include all modifications, equivalents, and alternatives of the embodiments and the terms.

Like numbers refer to like elements throughout the description of the drawings.

The singular forms preceded by “a,” “an,” and “the” corresponding to an item are intended to include the plural forms as well unless the context clearly indicates otherwise.

In the present disclosure, a phrase such as “A or B,” “at least one of A and B,” “at least one of A or B,” “A, B or C,” “at least one of A, B and C,” and “at least one of A, B, or C” may include any one of the items listed together in the corresponding phrase of the phrases, or any possible combination thereof.

The term “and/or” includes combinations of one or all of a plurality of associated listed items.

As used herein, such terms as “1st” and “2nd,” or “first” and “second” may be used to simply distinguish a corresponding component from another, and does not limit the components in other aspect (e.g.., importance or order).

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that the terms “include,” “comprise” and/or “have” when used in this specification, specify the presence of stated features, integers, steps, operations, elements, and/or components, but do not preclude the presence or addition of one or more other features, integers, steps, operations, elements, components, and/or groups thereof.

It is to be understood that if a certain component is referred to as being “coupled with,” “coupled to,” “supported on” or “in contact with” another component, it means that the component may be coupled with the other component directly or indirectly via a third component.

It will also be understood that when a component is referred to as being “on” another component, it may be directly on the other component or intervening components may also be present.

The terms of “part,” “module,” and “member” may be implemented in hardware or software. In some embodiments, a plurality of “parts,” “modules,” and “members” may be implemented as a single component. In some embodiments, a single “part,” “module,” and “member” may include multiple components.

The terms, such as “part,” “device,” “block,” “member,” module,” and the like may refer to a unit for processing at least one function or act. For example, the terms may refer to at least one hardware (e.g., a field-programmable gate array (FPGA) and/or application specific integrated circuit (ASIC)) and/or software stored in memory.

In each step, an identification symbol may be used to refer to each step. However, the identification symbol does not limit the order of each step, and each step may be performed in an order different from the described order unless the context clearly requires a specific order.

The terms “front,” “rear,” “left,” “right,” “upper,” “lower,” and the like used in the following description are defined based on the drawings. However, the shapes and positions of the respective components are not limited by these terms. For example, the front side may be defined as the +X direction and the rear side as the -X direction. For example, based on the drawings, the left side may be defined as the +Y direction and the right side as the -Y direction. For example, based on the drawings, the upper side may be defined as the +Z direction and the lower side as the -Z direction.

Hereinafter non-limiting example embodiments of the present disclosure will be described in detail with reference to the accompanying drawings.

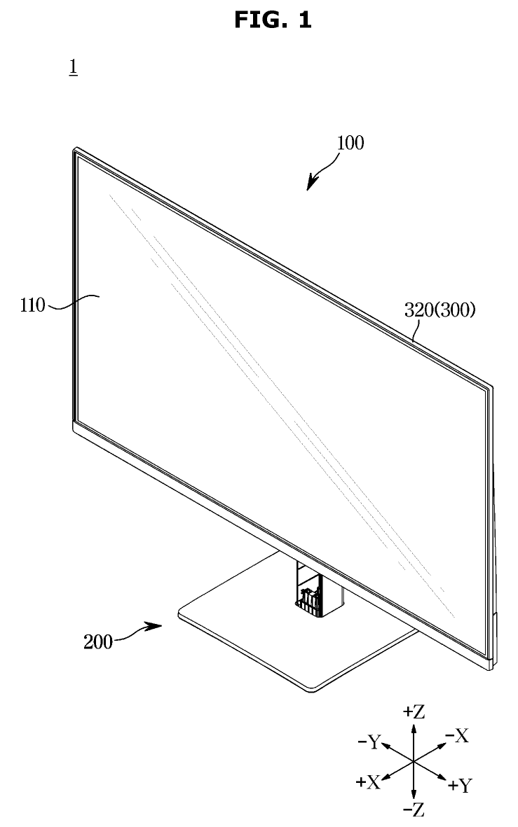

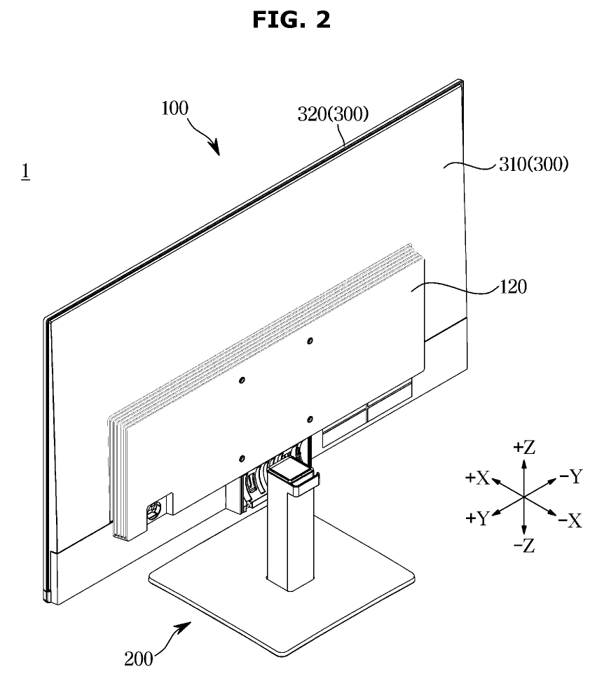

FIG. 1 is a view illustrating a display apparatus and a stand according to an embodiment. FIG. 2 is a view illustrating the display apparatus and the stand according to an embodiment.

Referring to FIGS. 1 and 2, the display assembly 1 may include a display apparatus 100, and a stand 200 configured to support the display apparatus 100. The display assembly 1 may be a device that displays information, data, and the like in the form of characters, figures, graphs, images, and the like, and may include a television, a monitor, and the like.

The display apparatus 100 may include a display panel 110. The display panel 110 may be configured to display a screen. The display panel 110 may be a self-luminous display panel such as an organic light-emitting diode (OLED), and a non-self-luminous display panel such as a liquid crystal display (LCD). However, there is no limitation on the type of display panel 110.

The display apparatus 100 may include a chassis 300. The chassis 300 may support the display panel 110. The chassis 300 may receive the display panel 110. The chassis 300 may form an exterior of the display apparatus 100.

The chassis 300 may include a rear chassis 310. The rear chassis 310 may be provided behind the display panel 110. The rear chassis 310 may cover a rear side of the display panel 110.

The chassis 300 may include a front chassis 320. The front chassis 320 may be provided along an edge of the display panel 110. The front chassis 320 may cover the edge of the display panel 110. The front chassis 320 may be provided on a front side of the rear chassis 310.

The display apparatus 100 may include a rear cover 120. The rear cover 120 may cover the rear side of the chassis 300. The rear cover 120 may be coupled to the rear side of the chassis 300. For example, the rear cover 120 may cover the rear side of the rear chassis 310. For example, the rear cover 120 may be coupled to the rear side of the rear chassis 310.

According to some embodiments, the display apparatus 100 may include a plurality of optical sheets, a backlight unit configured to emit light, a control module configured to control internal components of the display panel 110, and the like.

The display assembly 1 may include the stand 200. The stand 200 may be provided to support the display apparatus 100.

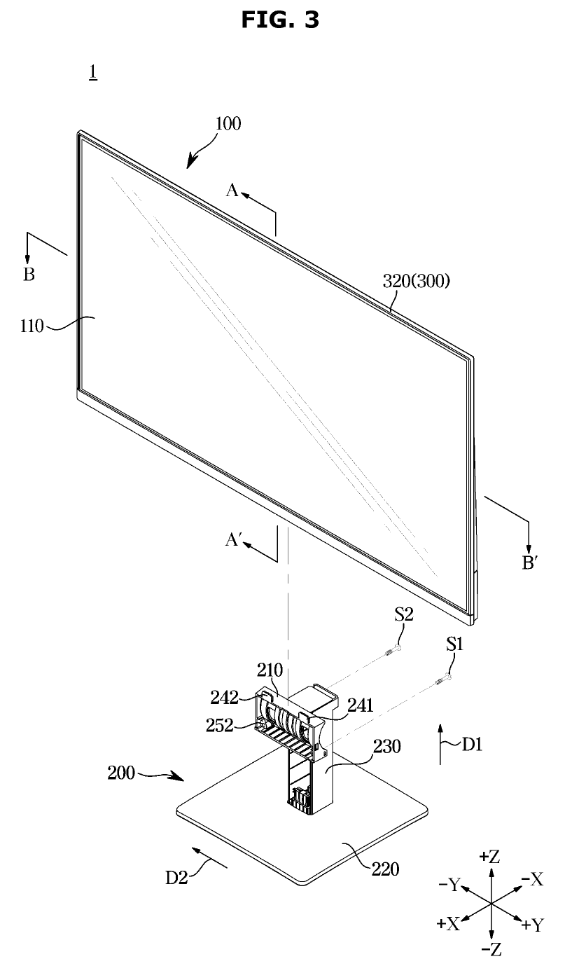

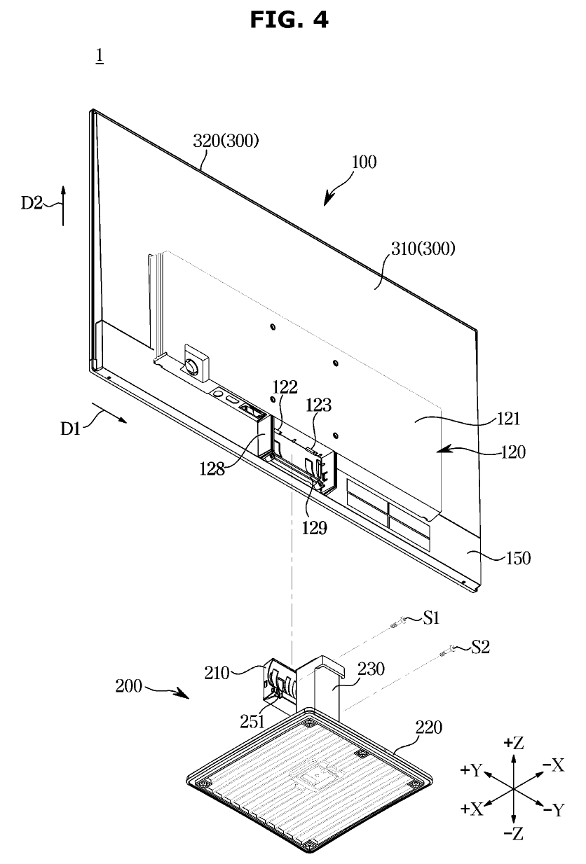

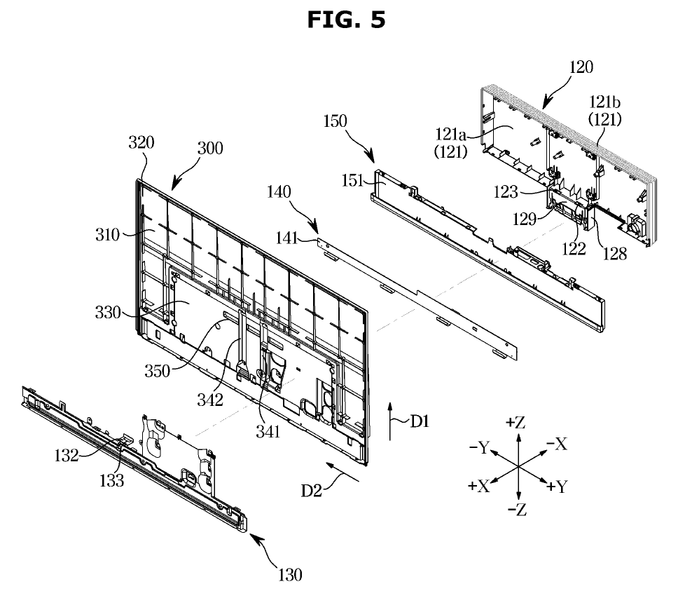

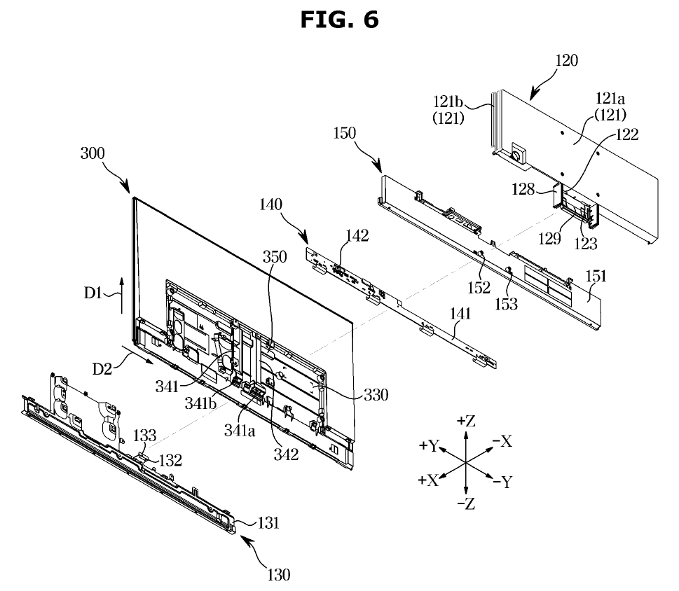

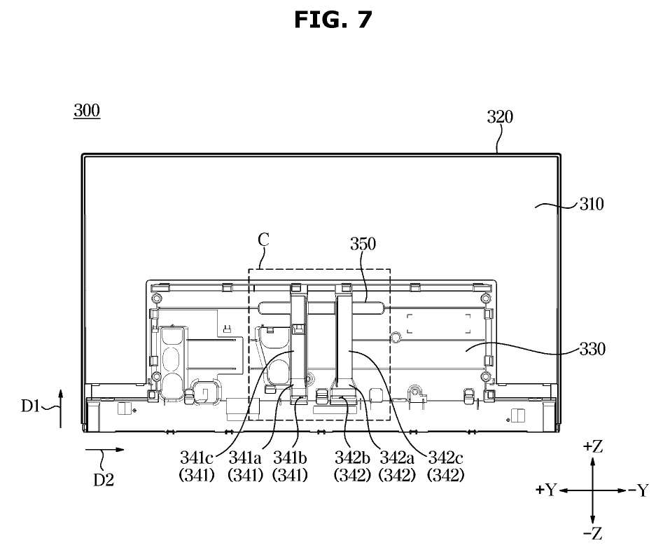

FIG. 3 is a view illustrating a state in which the display apparatus and the stand are separated according to an embodiment. FIG. 4 is a view illustrating the state in which the display apparatus and the stand are separated according to an embodiment. FIG. 5 is an exploded view of a chassis and peripheral components according to an embodiment. FIG. 6 is an exploded view of the chassis and the peripheral components according to an embodiment. FIG. 7 is a rear view of the chassis according to an embodiment.

Referring to FIGS. 3 to 7, the stand 200 may be detachably coupled to the display apparatus 100. For example, the stand 200 may be detachably coupled to a lower portion of a rear surface of the display apparatus 100. With the configuration, the display apparatus 100 may be spaced apart from a floor surface on which the display assembly 1 is placed.

The stand 200 may include a stand body 210. When the stand 200 is coupled to the display apparatus 100, the stand body 210 may be coupled to the rear cover 120. When the stand 200 is coupled to the display apparatus 100, the stand body 210 may be mounted on a stand mounting portion 129 disposed between two guide walls 128 formed in a lower portion of a rear surface of the rear cover 120.

The stand 200 may include a stand base 220. The stand base 220 may be provided to support the stand body 210. The stand base 220 may be provided on one side of the stand body 210. For example, the stand base 220 may be provided on a lower side of the stand body 210.

The stand 200 may include a stand leg 230. The stand leg 230 may connect the stand body 210 and the stand base 220. The stand leg 230 may extend along a first direction D1. For example, the stand leg 230 may extend in an up and down direction (e.g., Z-axis direction).

The stand 200 may include a first insertion protrusion 241. The first insertion protrusion 241 may protrude from the stand body 210. The first insertion protrusion 241 may be provided on another side of the stand body 210 opposite to the one side. For example, the first insertion protrusion 241 may be provided on an upper side of the stand body 210 and may protrude upward from the stand body 210.

The stand 200 may include a second insertion protrusion 242. The second insertion protrusion 242 may protrude from the stand body 210. The second insertion protrusion 242 may be provided on the another side of the stand body 210 opposite to one side. For example, the second insertion protrusion 242 may be provided on the upper side of the stand body 210 and may protrude upward from the stand body 210.

The second insertion protrusion 242 may be spaced apart from the first insertion protrusion 241 with respect to a second direction D2 intersecting the first direction D1. In other words, the first insertion protrusion 241 and the second insertion protrusion 242 may be provided side by side in the second direction D2. For example, the second insertion protrusion 242 may be provided on a right side (e.g., -Y direction) of the first insertion protrusion 241.

When the stand 200 is coupled to the display apparatus 100, the first insertion protrusion 241 may be inserted into a first through-hole 122 and a first insertion hole 341b to be described later. When the stand 200 is coupled to the display apparatus 100, the second insertion protrusion 242 may be inserted into a second through-hole 123 and a second insertion hole 342b to be described later. Details thereof will be described later.

Although it is illustrated that the stand 200 includes two insertion protrusions (e.g., the first insertion protrusion 241 and the second insertion protrusion 242), there is no particular limitation on the number of insertion protrusions. For example, a single insertion protrusion may be provided, or three or more of insertion protrusions may be provided.

The stand 200 may include a first fastening member through-hole 251. A first fastening member S1, which will be described later, may be inserted into the first fastening member through-hole 251. The first fastening member through-hole 251 may be provided at the lower portion of the stand body 210. However, there is no particular limitation on the position of the first fastening member through-hole 251.

The stand 200 may include a second fastening member through-hole 252. A second fastening member S2, which will be described later, may be inserted into the second fastening member through-hole 252. The second fastening member through-hole 252 may be provided at the lower portion of the stand body 210. However, there is no particular limitation on the position of the second fastening member through-hole 252.

The second fastening member through-hole 252 may be spaced apart from the first fastening member through-hole 251 with respect to the second direction D2. In other words, the first fastening member through-hole 251 and the second fastening member through-hole 252 may be provided side by side in the second direction D2. For example, the second fastening member through-hole 252 may be provided on the right side (e.g., -Y direction) of the first fastening member through-hole 251.

The first fastening member S1 may be inserted and fastened into the first fastening member through-hole 251 and a first fastening member insertion groove 152 to be described later, and the second fastening member S2 may be inserted and fastened into the second fastening member through-hole 252 and a second fastening member insertion groove 153 to be described later, thereby allowing the stand 200 to be fixed to the display apparatus 100. This will be described in more detail later.

Although it is illustrated that the stand 200 includes two fastening member through-holes (e.g., the first fastening member through-hole 251 and the second fastening member through-hole 252), there is no particular limitation on the number of fastening member through-holes. For example, a single fastening member through-hole may be provided or three or more of fastening member through-holes may be provided.

The display apparatus 100 may include the chassis 300. The chassis 300 may include the rear chassis 310, and the front chassis 320.

The chassis 300 may include a base plate 330. The base plate 330 may be provided behind the display panel 110. The base plate 330 may be provided at an inner side of the rear chassis 310. The base plate 330 may be formed to have a stepped shape on a rear surface of the rear chassis 310. A first bead 341, a second bead 342, a third bead 350, a rear cover coupling portion 360, and a connecting rib 370, which will be described later, may be provided on the base plate 330.

The base plate 330 may be formed integrally with the rear chassis 310 and the front chassis 320. For example, the rear chassis 310, the front chassis 320, and the base plate 330 may be formed by injection molding. That is, the chassis 300 may be formed by injection molding.

The rear chassis 310, the front chassis 320, and the base plate 330 may include a resin material. That is, the chassis 300 may include a resin material.

According to some embodiments of the present disclosure, the chassis 300 may be formed by injection molding using a resin material. Due to the configuration, a manufacturing cost and material cost of the display apparatus 100 may be relatively reduced.

The chassis 300 may include the first bead 341. The first bead 341 may protrude from the base plate 330. For example, the first bead 341 may protrude rearward from the base plate 330. For this, the first bead 341 may be formed to be recessed in a front surface of the base plate 330. In other words, the first bead 341 may be formed to be raised from the rear surface of the base plate 330. Accordingly, a hollow may be formed on an inner side of the first bead 341.

The first bead 341 may extend along one direction. For example, the first bead 341 may extend along the first direction D1. In other words, the first bead 341 may extend in the up and down direction (e.g., Z-axis direction).

The first bead 341 may include a first stand coupling portion 341a. The first stand coupling portion 341a may protrude from the base plate 330. For example, the first stand coupling portion 341a may protrude rearward from the base plate 330. For this, the first stand coupling portion 341a may be formed to be recessed in the front surface of the base plate 330. Accordingly, a hollow may be formed on an inner side of the first stand coupling portion 341a.

The first stand coupling portion 341a may include the first insertion hole 341b into which at least a portion of the stand 200 is inserted. For this, the first insertion hole 341b may be open in a direction opposite to the direction into which at least a portion of the stand 200 is inserted.

For example, when the stand 200 is coupled to the display apparatus 100, the first insertion protrusion 241 may be inserted into the first insertion hole 341b in the first direction D1. For this, the first insertion hole 341b may be opened in a direction opposite to the first direction D1.

For example, when the stand 200 is coupled to the display apparatus 100, the first insertion protrusion 241 may be inserted upward into the first insertion hole 341b. The first insertion hole 341b may be open downward from a lower surface of the first stand coupling portion 341a to allow the first insertion protrusion 241 to be inserted upward. That is, the first insertion hole 341b may be open downward at a lower end of the first bead 341.

The first bead 341 may include a first extension portion 341c. The first extension portion 341c may protrude from the base plate 330. For example, the first extension portion 341c may protrude rearward from the base plate 330. For this, the first extension portion 341c may be formed by being recessed in the front surface of the base plate 330. Accordingly, a hollow may be formed on an inner side of the first extension portion 341c.

The first extension portion 341c may extend along one direction. For example, the first extension portion 341c may extend along the first direction D1. In other words, the first extension portion 341c may extend in the up and down direction (e.g., Z-axis direction).

The first extension portion 341c may extend in one direction from the first stand coupling portion 341a. For example, the first extension portion 341c may extend in the first direction D1 from the first stand coupling portion 341a. In other words, the first extension portion 341c may extend upward (e.g., +Z direction) from the first stand coupling portion 341a. Accordingly, one end of the first extension portion 341c may be connected to the first stand coupling portion 341a, and an opposite end of the first extension portion 341c may be provided at a position adjacent to an edge of the base plate 330.

The chassis 300 may include the second bead 342. The second bead 342 may protrude from the base plate 330. For example, the second bead 342 may protrude rearward from the base plate 330. For this, the second bead 342 may be formed by being recessed in the front surface of the base plate 330. Accordingly, a hollow may be formed on an inner side of the second bead 342.

The second bead 342 may be spaced apart from the first bead 341 with respect to the second direction D2. In other words, the first bead 341 and the second bead 342 may be provided side by side in the second direction D2. For example, the second bead 342 may be provided on the right side (e.g., -Y direction) of the first bead 341.

The second bead 342 may extend along one direction. For example, the second bead 342 may extend along the first direction D1. In other words, the second bead 342 may extend in the up and down direction (e.g., Z-axis direction).

The second bead 342 may include a second stand coupling portion 342a. The second stand coupling portion 342a may protrude from the base plate 330. For example, the second stand coupling portion 342a may protrude rearward from the base plate 330. For this, the second stand coupling portion 342a may be formed to be recessed in the front surface of the base plate 330. In other words, the second bead 342 may be formed to be raised from the rear surface of the base plate 330. Accordingly, a hollow may be formed on an inner surface of the second stand coupling portion 342a.

The second stand coupling portion 342a may be spaced apart from the first stand coupling portion 341a with respect to the second direction D2. In other words, the first stand coupling portion 341a and the second stand coupling portion 342a may be provided side by side in the second direction D2. For example, the second stand coupling portion 342a may be provided on the right side (e.g., -Y direction) of the first stand coupling portion 341a.

The second stand coupling portion 342a may include the second insertion hole 342b into which at least a portion of the stand 200 is inserted. For this, the second insertion hole 342b may be open in a direction opposite to the direction into which at least a portion of the stand 200 is inserted.

For example, when the stand 200 is coupled to the display apparatus 100, the second insertion protrusion 242 may be inserted into the second insertion hole 342b in the first direction D1. For this, the second insertion hole 342b may be open in a direction opposite to the first direction D1.

For example, when the stand 200 is coupled to the display apparatus 100, the second insertion protrusion 242 may be inserted upward into the second insertion hole 342b. The second insertion hole 342b may be open downward from a lower surface of the second stand coupling portion 342a to allow the second insertion protrusion 242 to be inserted upward. That is, the second insertion hole 342b may be open downward at a lower end of the second bead 342.

The second bead 342 may include a second extension portion 342c. The second extension portion 342c may protrude from the base plate 330. For example, the second extension portion 342c may protrude rearward from the base plate 330. For this, the second extension portion 342c may be formed by being recessed in the front surface of the base plate 330. Accordingly, a hollow may be formed on an inner side of the second extension portion 342c.

The second extension portion 342c may be spaced apart from the first extension portion 341c with respect to the second direction D2. In other words, the first extension portion 341c and the second extension portion 342c may be provided side by side in the second direction D2. For example, the second extension portion 342c may be provided on the right side (e.g., -Y direction) of the first extension portion 341c.

The second extension portion 342c may extend along one direction. For example, the second extension portion 342c may extend along the first direction D1. In other words, the second extension portion 342c may extend in the up and down direction (e.g., Z-axis direction).

The second extension portion 342c may extend in one direction from the second stand coupling portion 342a . For example, the second extension portion 342c may extend in the first direction D1 from the second stand coupling portion 342a. In other words, the second extension portion 342c may extend upward (e.g., +Z direction) from the second stand coupling portion 342a. Accordingly, one end of the second extension portion 342c may be connected to the second stand coupling portion 342a, and the other end of the second extension portion 342c may be provided at a position adjacent to the edge of the base plate 330.

The chassis 300 may include the third bead 350. The third bead 350 may protrude from the base plate 330. For example, the third bead 350 may protrude rearward from the base plate 330. For this, the third bead 350 may be formed to be recessed in the front surface of the base plate 330. In other words, the third bead 350 may be formed to be raised from the rear surface of the base plate 330. Accordingly, a hollow may be formed on an inner side of the third bead 350.

The third bead 350 may extend along one direction. For example, the third bead 350 may extend along the second direction D2. In other words, the third bead 350 may extend in the left and right direction (e.g., Y-axis direction).

The third bead 350 may be arranged to cross the first bead 341 and the second bead 342. For example, the third bead 350 may be arranged to cross approximately an upper portion of the first bead 341 and an upper portion of the second bead 342.

A length at which the third bead 350 protrudes from the base plate 330 may be less than a length at which each of the first bead 341 and the second bead 342 protrudes from the base plate 330. For example, the third bead 350 may be shorter than the first bead 341 and the second bead 342.

As described above, the chassis 300 may be formed by injection molding using a resin material. When a rigidity of a chassis is not additionally reinforced, the chassis may have a lower rigidity than a chassis manufactured through a press process using a metal material. The lower the rigidity of the chassis, the higher the possibility of damage to the display apparatus.

For example, when a user lifts the display apparatus by holding only one end of the display apparatus, torque may be applied to the display apparatus due to a weight of the display apparatus. Accordingly, one end or the other end of the display apparatus may be bent or shaken, and this may possibly result in damage to the display apparatus in a comparative embodiment.

In particular, in order to couple the display apparatus to the stand, a first insertion protrusion and a second insertion protrusion may be required to be inserted into a first insertion hole and a second insertion hole. In this process, a user can apply an unintended external force to the stand coupling portions (e.g., the first stand coupling portion and the second stand coupling portion), which may cause the lower or upper portion of the display apparatus to be bent or shaken in the comparative embodiment.

According to embodiments of the present disclosure, the chassis 300 may include the plurality of beads (e.g., the first bead 341, the second bead 342, and the third bead 350). Each of the plurality of beads (e.g., the first bead 341, the second bead 342, and the third bead 350) may protrude rearward from the base plate 330. With the configuration, the torque resistance of the chassis 300 may be increased, and the rigidity of the chassis 300 may be reinforced by dispersing a load concentrated on one portion of the chassis 300.

For example, each of the first bead 341 and the second bead 342 may extend in the up and down direction (e.g., Z-axis direction). Accordingly, each of the first bead 341 and the second bead 342 may prevent the lower or upper portion of the display apparatus 100 from being bent or shaken.

For example, the third bead 350 may extend in the left and right directions (e.g., Y-axis direction). Accordingly, the third bead 350 may prevent the left end (e.g., +Y direction) or the right end (e.g., -Y direction) of the display apparatus 100 from being bent or shaken.

For example, a portion of the first bead 341 may extend upward (e.g., +Z direction) from the first stand coupling portion 341a, and a portion of the second bead 342 may extend upward (e.g., +Z direction) from the second stand coupling portion 342a. Accordingly, each of the first bead 341 and the second bead 342 may disperse a load, which may be concentrated on the stand coupling portions (e.g., the first stand coupling portion 341a and the second stand coupling portion 342a) of the chassis 300 and an adjacent portion thereof when coupling the display apparatus 100 and the stand 200, and each of the first bead 341 and the second bead 342 may prevent the lower or upper portion of the display apparatus 100 from being bent or shaken.

In particular, the third bead 350 may be arranged to cross the first bead 341 and the second bead 342. Accordingly, the third bead 350 may additionally distribute the load applied to the first bead 341 and the second bead 342.

That is, because the chassis 300 includes the plurality of beads (e.g., the first bead 341, the second bead 342, and the third bead 350), the chassis 300 may be prevented from being bent, and damage to the display apparatus 100 may be prevented.

According to embodiments the present disclosure, the first bead 341 and the second bead 342 may respectively include the first insertion hole 341b and the second insertion hole 342b that reinforce the rigidity of the chassis 300 and are open to allow a portion of the stand 200 to be inserted thereinto. For example, the first insertion protrusion 241 of the stand 200 may be inserted into the first insertion hole 341b of the first bead 341, and the second insertion protrusion 242 of the stand 200 may be inserted into the second insertion hole 342b of the second bead 342. With the configuration, the display apparatus 100 may be stably supported on the stand 200, and alignment between the stand 200 and the display apparatus 100 may be maintained. Accordingly, a separate connection bracket to assist in connecting the display apparatus 100 and the stand 200 may be omitted.

Although it is illustrated that the chassis 300 includes three beads (e.g., the first bead 341, the second bead 342, and the third bead 350), there is no particular limitation on the number of beads. For example, two or fewer beads may be provided, or four or more beads may be provided. In addition, there is no particular limitation on a position at which an additional bead is formed, or a direction in which the bead extends.

In addition, an embodiment in which the chassis 300 includes the plurality of beads (e.g., the first bead 341, the second bead 342, and the third bead 350) including the hollow formed therein, is described in the above description. However, according to embodiments, the chassis 300 may include a plurality of ribs in which a hollow is not formed. In this case, the plurality of ribs may be provided to protrude rearward from the base plate 330, thereby reinforcing the rigidity of the chassis 300.

The display apparatus 100 may include the rear cover 120. The rear cover 120 may be coupled to the rear side of the chassis 300 to cover the rear side of the chassis 300. For example, the rear cover 120 may be coupled to the rear side of the base plate 330 to cover the rear side of the base plate 330.

The rear cover 120 may include a rear cover body 121. The rear cover body 121 may form an overall appearance of the rear cover 120.

The rear cover body 121 may include a cover plate 121a, and a side wall portion 121b that is bent from an edge of the cover plate 121a. The cover plate 121a may be spaced apart from the base plate 330, and one end of the side wall portion 121b may come into contact with the base plate 330 to support the cover plate 121a.

The rear cover 120 may include the first through-hole 122. The first through-hole 122 may be provided to allow at least a portion of the stand 200 to be inserted thereinto. For example, the first through-hole 122 may be provided to allow the first insertion protrusion 241 to be inserted therein.

The first through-hole 122 may be provided at a position corresponding to the first insertion hole 341b. For example, the first through-hole 122 may be provided in the side wall portion 121b provided on a lower side of the cover plate 121a. For example, the first through-hole 122 may be provided on an upper side of the stand mounting portion 129.

The rear cover 120 may include the second through-hole 123. The second through-hole 123 may be provided to allow at least a portion of the stand 200 to be inserted thereinto. The second through-hole 123 may be provided to allow the second insertion protrusion 242 to be inserted thereinto.

The second through-hole 123 may be provided at a position corresponding to the second insertion hole 342b. For example, the second through-hole 123 may be provided in the side wall portion 121b provided on the lower side of the cover plate 121a. For example, the second through-hole 123 may be provided on the upper side of the stand mounting portion 129.

The second through-hole 123 may be spaced apart from the first through-hole 122 with respect to the second direction D2. In other words, the first through-hole 122 and the second through-hole 123 may be provided side by side in the second direction D2. For example, the second through-hole 123 may be provided on the right side (e.g., -Y direction) of the first through-hole 122.

When the stand 200 is coupled to the display apparatus 100, the first insertion protrusion 241 may be inserted into the first through-hole 122 and the first insertion hole 341b. When the stand 200 is coupled to the display apparatus 100, the second insertion protrusion 242 may be inserted into the second through-hole 123 and the second insertion hole 342b. With the configuration, the display apparatus 100 may be prevented from moving in a forward and backward direction (e.g., X-axis direction) or the left and right direction (e.g., Y-axis direction) with respect to the stand 200.

The display apparatus 100 may include a reinforcing bracket 130. The reinforcing bracket 130 may be arranged in a lower portion of the front surface of the rear chassis 310. In other words, the reinforcing bracket 130 may be coupled to the lower portion of the front surface of the rear chassis 310. With the configuration, the rigidity of the display apparatus 100 may be reinforced.

The reinforcing bracket 130 may include a bracket body 131, and a bracket bent portion 132 provided to be bent rearwardly from the bracket body 131. For example, the bracket bent portion 132 may extend rearward from the bracket body 131. A bracket hole 133 may be formed in the bracket bent portion 132.

The bracket hole 133 may be provided at a position corresponding to the second insertion hole 342b. Accordingly, when the stand 200 is coupled to the display apparatus 100, the second insertion protrusion 242 may be inserted into the second through-hole 123, the bracket hole 133, and the second insertion hole 342b. With the configuration, it is possible to distribute a load which the second stand coupling portion 342a may receive during a process of inserting the second insertion protrusion 242 into the second insertion hole 342b to couple the display apparatus 100 and the stand 200. Further, it is possible to more effectively prevent the lower or upper portion of the display apparatus 100 from being bent or shaken.

According to some embodiments of the present disclosure, the reinforcing bracket 130 may additionally include a bracket bent portion, in which a bracket hole is formed, at a position corresponding to the first insertion hole 341b. Accordingly, the lower or upper portion of the display apparatus 100 may be effectively prevented from being bent or shaken.

The display apparatus 100 may include a controller 140. The controller 140 may be configured to control the display apparatus 100. The controller 140 may include a printed circuit board 141, and a plurality of electrical components 142 mounted on the printed circuit board 141.

The controller 140 may be disposed under the base plate 330. The controller 140 may be disposed in the lower portion of the rear surface of the rear chassis 310. For example, the controller 140 may be coupled to the lower portion of the rear surface of the rear chassis 310.

The display apparatus 100 may include a lower cover 150. The lower cover 150 may cover the lower portion of the rear surface of the rear chassis 310. For example, the rear cover 120 may cover an upper portion and a central portion of the rear surface of the rear chassis 310 and the base plate 330, and the lower cover 150 may cover the lower portion of the rear surface of the rear chassis 310. The controller 140 may be disposed between the lower cover 150 and the rear chassis 310.

The lower cover 150 may include a lower cover body 151. The lower cover body 151 may be provided in a substantially plate shape.

The lower cover body 151 of the lower cover 150 may include the first fastening member insertion groove 152. The first fastening member S1 may be inserted into the first fastening member insertion groove 152. The first fastening member insertion groove 152 may be provided at a position corresponding to the first fastening member through-hole 251. For example, the first fastening member insertion groove 152 may be provided at a lower portion of the lower cover body 151.

The lower cover body 151 of the lower cover 150 may include the second fastening member insertion groove 153. The second fastening member S2 may be inserted into the second fastening member insertion groove 153. The second fastening member insertion groove 153 may be provided at a position corresponding to the second fastening member through-hole 252. For example, the second fastening member insertion groove 153 may be provided at the lower portion of the lower cover body 151.

The second fastening member insertion groove 153 may be spaced apart from the first fastening member insertion groove 152 with respect to the second direction D2. In other words, the first fastening member insertion groove 152 and the second fastening member insertion groove 153 may be provided side by side in the second direction D2. For example, the second fastening member insertion groove 153 may be provided on the right side (e.g., -Y direction) of the first fastening member insertion groove 152.

When the stand 200 is coupled to the display apparatus 100, the first fastening member S1 may be inserted and fastened to the first fastening member insertion groove 152 by passing through the first fastening member through-hole 251. In addition, when the stand 200 is coupled to the display apparatus 100, the second fastening member S2 may be inserted and fastened to the second fastening member insertion groove 153 by passing through the second fastening member through-hole 252. With the configuration, the stand 200 may be fixed to the display apparatus 100.

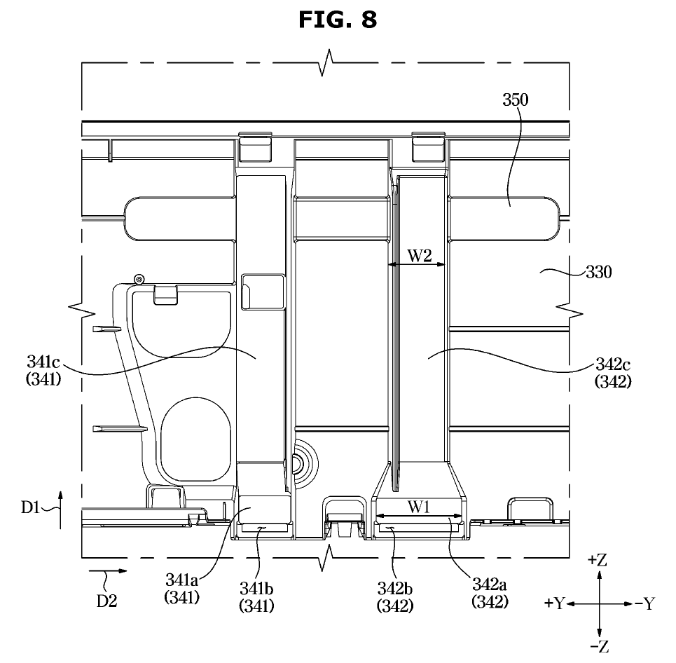

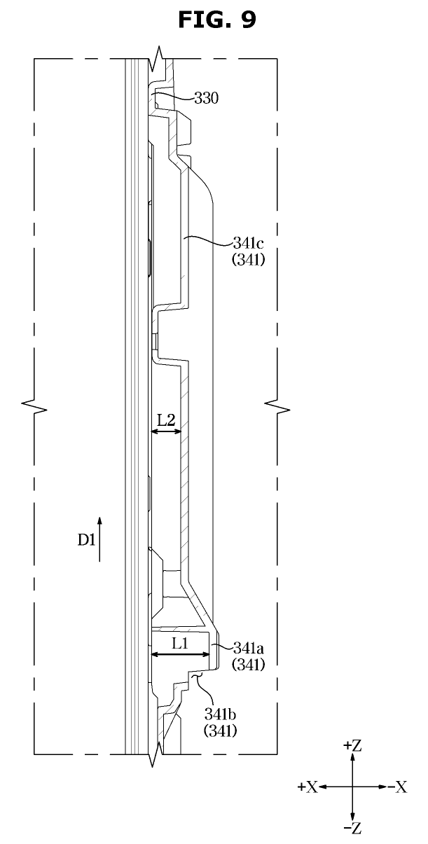

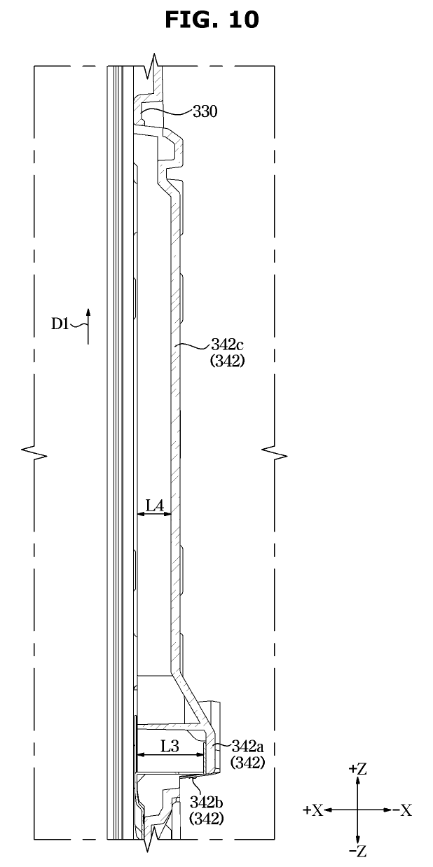

FIG. 8 is an enlarged view of a region C illustrated in FIG. 7. FIG. 9 is a cross-sectional view of a first bead according to an embodiment. FIG. 10 is a cross-sectional view of a second bead according to an embodiment.

Referring to FIGS. 8 to 10, a length L1 (e.g., depth) at which the first stand coupling portion 341a protrudes from the base plate 330 may be greater than a length L2 at which the first extension portion 341c protrudes from the base plate 330. In other words, a depth (e.g., length L1) at which the first stand coupling portion 341a is recessed in the front surface of the base plate 330 may be greater than a depth (e.g., length L2) at which the first extension portion 341c is recessed in the front surface of the base plate 330.

Additionally, a length L3 at which the second stand coupling portion 342a protrudes from the base plate 330 may be greater than a length L4 at which the second extension portion 342c protrudes from the base plate 330. In other words, a depth (e.g., length L3) at which the second stand coupling portion 342a is recessed in the front surface of the base plate 330 may be greater than a depth (e.g., length L4) at which the second extension portion 342c is recessed in the front surface of the base plate 330.

With the configuration, the rigidity of the stand coupling portions (e.g., the first stand coupling portion 341a and the second stand coupling portion 342a) may be further reinforced. Accordingly, during the process of inserting the first insertion protrusion 241 and the second insertion protrusion 242 into the first insertion hole 341b and the second insertion hole 342b to couple the display apparatus 100 and the stand 200, the lower or upper portion of the display apparatus 100 may be more effectively prevented from being bent or shaken.

A width W1 of the second stand coupling portion 342a along the second direction D2 may be greater than a width W2 of the second extension portion 342c along the second direction D2. With the configuration, the rigidity of the second stand coupling portion 342a may be further reinforced. Accordingly, during the process of inserting the second insertion protrusion 242 into the second insertion hole 342b to couple the display apparatus 100 and the stand 200, the lower or upper portion of the display apparatus 100 may be more effectively prevented from being bent or shaken.

According to some embodiments of the present disclosure, a width of the first stand coupling portion 341a along the second direction D2 may be formed to be greater than a width of the first extension portion 341c along the second direction D2. Accordingly, the lower or upper portion of the display apparatus 100 may be effectively prevented from being bent or shaken.

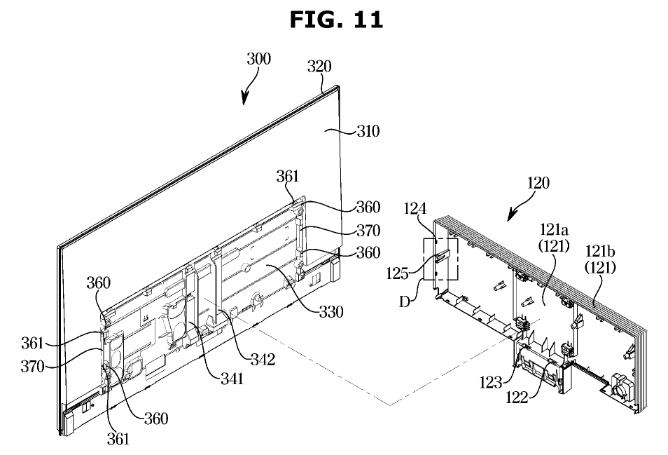

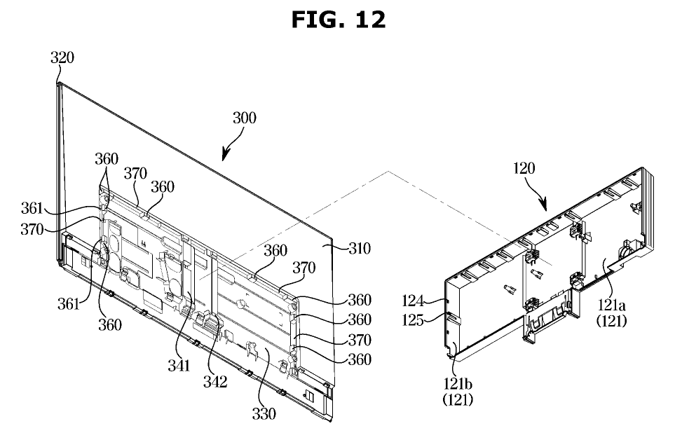

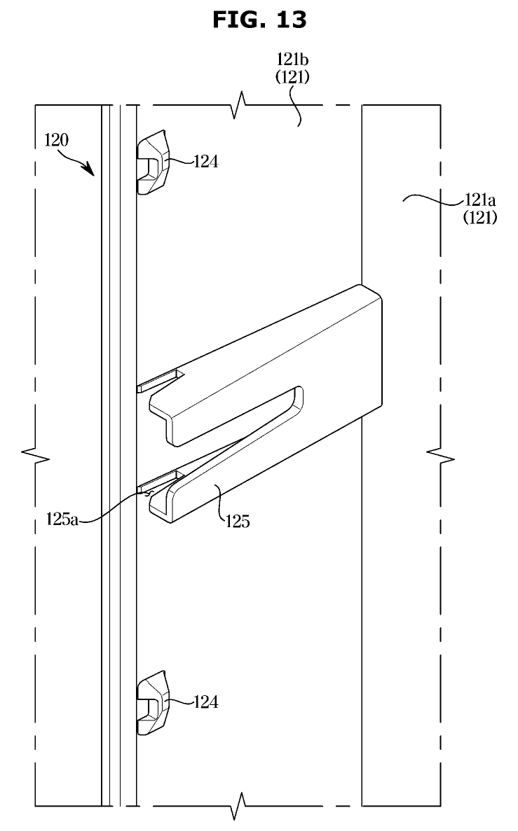

FIG. 11 is a view illustrating a state in which the chassis and a rear cover are separated according to an embodiment. FIG. 12 is a view illustrating the state in which the chassis and the rear cover are separated according to an embodiment. FIG. 13 is an enlarged view of a region D illustrated in FIG. 11.

Referring to FIGS. 11 to 13, the rear cover 120 may be coupled to the rear side of the base plate 330. The cover plate 121a may be spaced apart from the base plate 330, and one end of the side wall portion 121b may come into contact with the base plate 330 to support the cover plate 121a.

The rear cover 120 may include a hook 124. The hook 124 may be provided at an edge of the rear cover body 121. The hook 124 may protrude from the edge of the rear cover body 121 toward the inside of the rear cover body 121. For example, the hook 124 may protrude from an edge of the side wall portion 121b toward the inside of the rear cover body 121.

A plurality of hooks 124 may be provided. The plurality of hooks 124 may be arranged along the edge of the rear cover body 121. The plurality of hooks 124 may be spaced apart from each other. For example, the plurality of hooks 124 may be spaced apart from each other along the edge of the side wall portion 121b.

The rear cover 120 may include a plurality of cover guide portions 125. Each of the plurality of cover guide portions 125 may form a rib insertion groove 125a into which each of a plurality of connecting ribs 370 described below is inserted. This will be described in detail later.

The chassis 300 may include a rear cover coupling portion 360. The rear cover coupling portion 360 may be provided on the rear surface of the base plate 330. The rear cover coupling portion 360 may be provided at a position corresponding to the hook 124. For example, the rear cover coupling portion 360 may be provided at a position adjacent to the edge of the base plate 330.

The rear cover coupling portion 360 may include a hook insertion hole 361 into which the hook 124 is inserted. The hook insertion hole 361 may be provided at a position corresponding to the hook 124. The hook insertion hole 361 may be open toward the outside of the base plate 330. As the hook 124 is inserted to the hook insertion hole 361 of the rear cover coupling portion 360, the rear cover 120 may be coupled to the rear side of the base plate 330.

The rear cover coupling portion 360 may protrude from the base plate 330. For example, the rear cover coupling portion 360 may protrude rearward from the base plate 330. For this, the rear cover coupling portion 360 may be formed to be recessed in the front surface of the base plate 330. In other words, the rear cover coupling portion 360 may be formed to be raised from the rear surface of the base plate 330. With the configuration, the rear cover coupling portion 360 together with the plurality of beads (e.g., the first bead 341, the second bead 342, and the third bead 350) may reinforce the rigidity of the chassis 300.

In a process of inserting a hook into a hook insertion hole of a rear cover coupling portion so as to couple the rear cover to the rear side a the chassis, the rear cover or the chassis may be elastically deformed. When the hook is completely inserted into the hook insertion hole of the rear cover coupling portion, the elastically deformed components may be restored to the original shape thereof. Accordingly, in a comparative embodiment, the elastically deformed components may be damaged caused by the deformation.

According to embodiments of the present disclosure, the rear cover coupling portion 360, in which the hook insertion hole 361 is formed, may protrude from the base plate 330 and may have a predetermined size. For example, the rear cover coupling portion 360 may have a relatively large size compared to the hook 124. Accordingly, when the rear cover 120 is coupled to the rear side of the chassis 300, the rear cover 120 not the chassis 300 may primarily cause elastic deformation. Accordingly, the chassis 300 may be prevented from being damaged.

A plurality of rear cover coupling portions 360 may be provided. The plurality of rear cover coupling portions 360 may be arranged along the edge of the base plate 330. The plurality of rear cover coupling portions 360 may be spaced apart from each other. The plurality of rear cover coupling portions 360 may be provided at positions corresponding to each of the plurality of hooks 124 to be connected to the plurality of hooks 124, respectively.

The chassis 300 may include the plurality of connecting ribs 370. Each of the plurality of connecting ribs 370 may connect two adjacent rear cover coupling portions 360 among the plurality of rear cover coupling portions 360. Each of the plurality of connecting ribs 370 may extend between two adjacent rear cover coupling portions 360 among the plurality of rear cover coupling portions 360.

Each of the plurality of connecting ribs 370 may protrude from the base plate 330. For example, each of the plurality of connecting ribs 370 may protrude rearward from the base plate 330. With the configuration, each of the plurality of connecting ribs 370 together with the plurality of beads (e.g., the first bead 341, the second bead 342, and the third bead 350) may reinforce the rigidity of the chassis 300.

Each of the plurality of connecting ribs 370 may be provided to be inserted into the rib insertion groove 125a formed in each of the plurality of cover guide portions 125. Accordingly, when the rear cover 120 is coupled to the base plate 330, the connecting rib 370 may be inserted into the rib insertion groove 125a and thus the cover guide portion 125 may guide the rear cover 120 to be coupled to a correct position on the base plate 330.

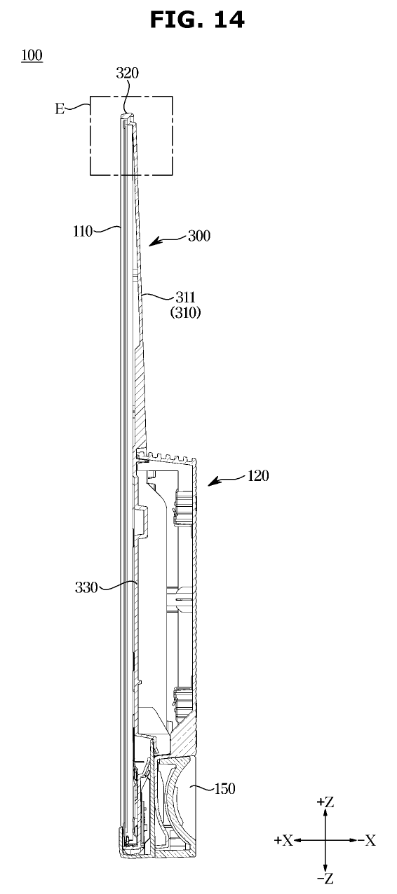

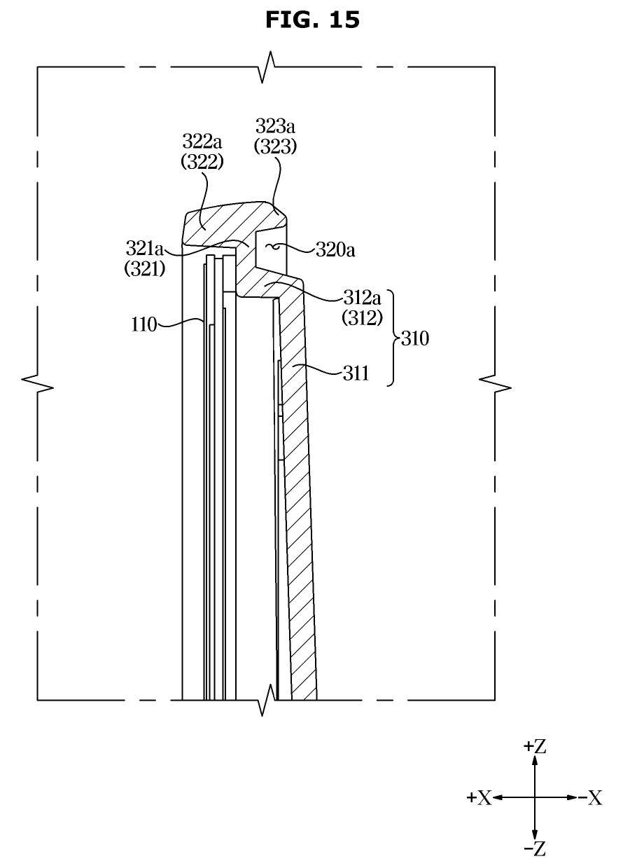

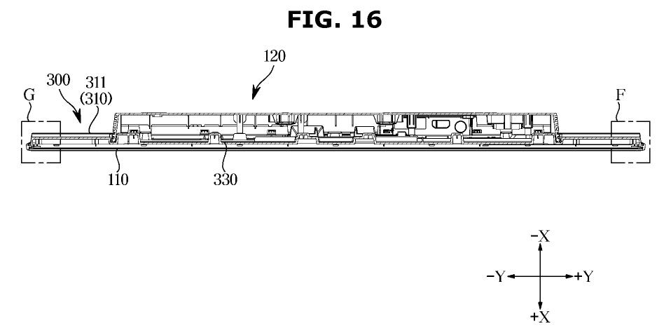

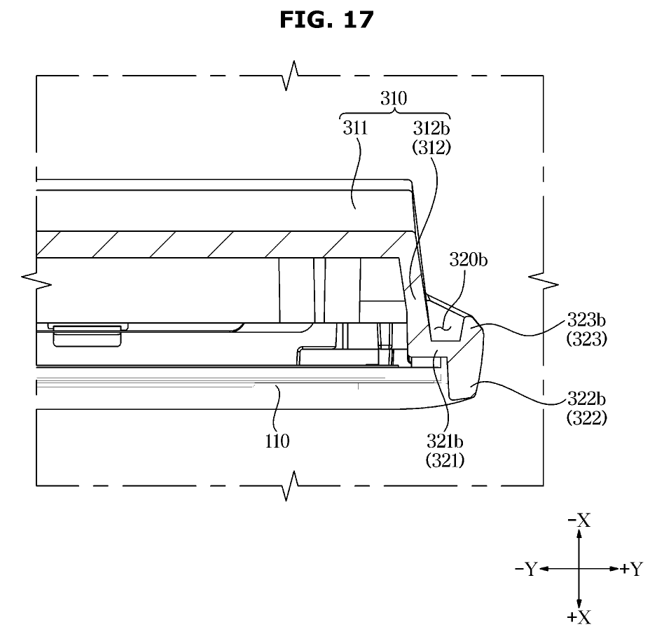

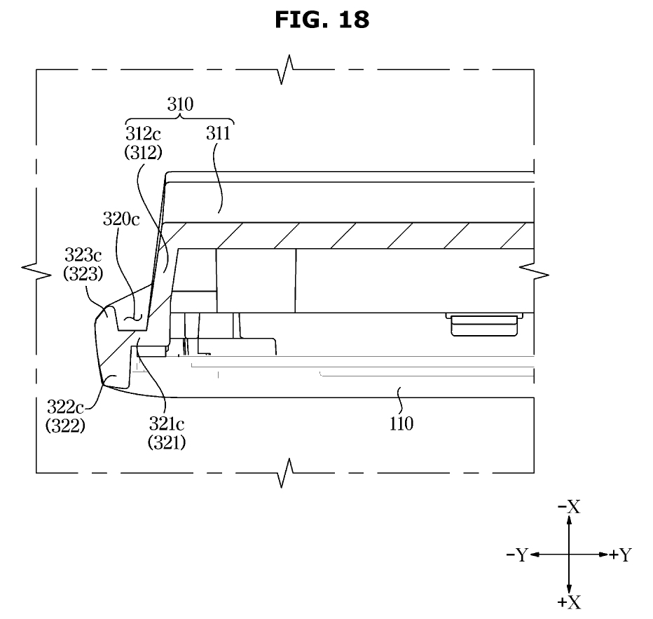

FIG. 14 is a cross-sectional view taken along a line A-A’ illustrated in FIG. 3. FIG. 15 is an enlarged view of a region E illustrated in FIG. 14. FIG. 16 is a cross-sectional view taken along a line B-B’ illustrated in FIG. 3. FIG. 17 is an enlarged view of a region F illustrated in FIG. 16. FIG. 18 is an enlarged view of a region G illustrated in FIG. 16.

Referring to FIGS. 14 to 18, the rear chassis 310 may cover the rear side of the display panel 110, and the front chassis 320 may cover the edge of the display panel 110.

The rear chassis 310 may include a chassis plate 311. The chassis plate 311 may form an overall appearance of the rear chassis 310. The chassis plate 311 may be provided behind the display panel 110. The base plate 330 may be provided on the inner side of the chassis plate 311.

The rear chassis 310 may include at least one chassis bent portion 312. The at least one chassis bent portion 312 may be bent forward from an edge of the chassis plate 311. For example, the at least one chassis bent portion 312 may include a first chassis bent portion 312a that is bent forward from an upper edge (e.g., +Z direction) of the chassis plate 311, a second chassis bent portion 312b that is bent forward from a left edge (e.g., +Y direction) of the chassis plate 311, and a third chassis bent portion 312c that is bent forward from a right edge (e.g., -Y direction) of the chassis plate 311. For example, the first chassis bent portion 312a, the second chassis bent portion 312b, and the third chassis bent portion 312c may extend forward from the chassis plate 311.

The front chassis 320 may include at least one protruding rib 321. The protruding rib 321 may protrude from the edge of the rear chassis 310 to an outer direction of the rear chassis 310. For example, the protruding rib 321 may protrude from an edge of the chassis bent portion 312 to the outer direction of the rear chassis 310. In other words, the protruding rib 321 may protrude from the edge of the chassis bent portion 312 to a direction intersecting a direction in which the chassis bent portion 312 extends. For example, the protruding rib 321 may include a first protruding rib 321a protruding upward from an upper edge (e.g., +Z direction) of the first chassis bent portion 312a, a second protruding rib 321b protruding to the left direction (+Y direction) from a left edge (e.g., +Y direction) of the second chassis bent portion 312b, and a third protruding rib 321c protruding to the right direction (e.g., -Y direction) from a right edge (e.g., -Y direction) of the third chassis bent portion 312c.

The front chassis 320 may include at least one front protrusion 322. The at least one front protrusion 322 may protrude forward from one end of the at least one protruding rib 321. The at least one front protrusion 322 may cover the edge of the display panel 110. For example, the at least one front protrusion 322 may include a first front protrusion 322a protruding forward from an upper end (e.g., +Z direction) of the first protruding rib 321a, a second front protrusion 322b protruding forward from a left end (e.g., +Y direction) of the second protruding rib 321b, and a third front protrusion 322c protruding forward from a right end (e.g., -Y direction) of the third protruding rib 321c.

The front chassis 320 may include at least one rear protrusion 323. The at least one rear protrusion 323 may protrude rearward from one end of the at least one protruding rib 321. That is, the at least one rear protrusion 323 may protrude rearward from one end of the at least one protruding rib 321 in a direction opposite to the direction in which the front protrusion 322 protrudes. For example, the at least one rear protrusion 323 may include a first rear protrusion 323a protruding rearward from the upper end (e.g., +Z direction) of the first protruding rib 321a, a second rear protrusion 323b protruding rearward from the left end (e.g., +Y direction) of the second protruding rib 321b, and a third rear protrusion 323c protruding rearward from the right end (e.g., -Y direction) of the third protruding rib 321c.

The at least one chassis bent portion 312, the at least one protruding rib 321, the at least one front protrusion 322, and the at least one rear protrusion 323 may form approximately an ‘ h ‘ shape. In particular, the at least one chassis bent portion 312, the at least one protruding rib 321, and the at least one rear protrusion 323 may form grooves (e.g., a first groove portion 320a, a second groove portion 320b, and a third groove portion 320c) that are open rearward. For example, the first chassis bent portion 312a, the first protruding rib 321a, and the first rear protrusion 323a may form (e.g., define) a first groove portion 320a that is open rearward. For example, the second chassis bent portion 312b, the second protruding rib 321b, and the second rear protrusion 323b may form (e.g., define) a second groove portion 320b that is opened rearward. For example, the third chassis bent portion 312c, the third protruding rib 321c, and the third rear protrusion 323c may form (e.g., define) a third groove portion 320c that is open rearward.

As described above, the front chassis 320 may include the front protrusion 322 covering the edge of the display panel 110, and the rear protrusion 323 provided on the opposite side of the front protrusion 322 with respect to the protruding rib 321. With the configuration, a load that the front chassis 320 may receive due to an external force may be distributed. Accordingly, the rigidity of the front chassis 320 may be reinforced without significantly changing the overall appearance of the chassis 300.

As described above, an embodiment may be provided in which the manufacturing cost and material cost of the display apparatus 100 may be relatively reduced through the chassis 300 formed by injection molding using a resin material, while the rigidity of the chassis 300 may be reinforced through the plurality of beads (e.g., the first bead 341, the second bead 342, and the third bead 350). However, embodiments of the present disclosure are not limited thereto. For example, even when the chassis includes a metal material or is formed through a press process, the rigidity of the chassis may be reinforced as the plurality of beads (e.g., the first bead 341, the second bead 342, and the third bead 350) according to embodiments of the present disclosure is applied to the chassis.

The display apparatus 100 according to an embodiment is configured to be detachably coupled to the stand 200. The display apparatus 100 includes the display panel 110, and the chassis 300 configured to support the display panel 110. The chassis 300 includes the rear chassis 310 behind the display panel 110, the front chassis 320 covering the edge of the display panel 110 on the front side of the rear chassis 310, the base plate 330 on the inner side of the rear chassis 310, and the beads (e.g., the first bead 341 and the second bead 342) recessed in the front surface of the base plate 330 so as to protrude rearward from the base plate 330. The beads (e.g., the first bead 341 and the second bead 342) includes the stand coupling portions (e.g., the first stand coupling portion 341a and the second stand coupling portion 342a) including the first insertion hole 341b and the second insertion hole 342b configured to receive at least a portion of the stand 200 in a first direction; and the extension portions (e.g., the first extension portion 341c and the second extension portion 342c) that extend in the first direction from the stand coupling portions (e.g., the first stand coupling portion 341a and the second stand coupling portion 342a).

The depths L1 and L3 at which the stand coupling portions (e.g., the first stand coupling portion 341a and the second stand coupling portion 342a) are recessed in the front surface of the base plate may be greater than the depths L2 and L4 at which the extension portions (e.g., the first extension portion 341c and the second extension portion 342c) are recessed in the front surface of the base plate 330.

The width of the first stand coupling portion 342a in the second direction D2 intersecting the first direction D1 may be greater than the width of the second extension portion 342c in the second direction.

The chassis 300 may further include the third bead 350 formed by being recessed in the front surface of the base plate 330 so as to protrude rearward from the base plate 330 and extends in a second direction intersecting the first direction.

The first insertion hole 341b and the second insertion hole 342b may be open downward and configured to upwardly receive at least a portion of the stand 200. The extension portions (e.g., the first extension portion 341c and the second extension portion 342c) may extend upward from the stand coupling portions (e.g., the first stand coupling portion 341a and the second stand coupling portion 342a).

The display apparatus 100 may further include the rear cover 120 covering the rear side of the chassis 300. The rear cover 120 may include the rear cover body 121, and the hook 124 on the edge of the rear cover body 121. The chassis 300 may further include the rear cover coupling portion 360 including the hook insertion hole 361 configured to receive the hook 124.

The rear cover coupling portion 360 may be recessed in the front surface of the base plate 330 so as to protrude rearward from the base plate 330.

The hook 124 may protrude from the edge of the rear cover body 121 toward the inside of the rear cover body 121. The hook insertion hole 361 may be open toward the outside of the base plate 330.

The rear cover 120 further comprises an additional hook 124 on the edge of the rear cover body 121, the chassis 300 further comprises an additional rear cover coupling portion 360 comprising an additional hook insertion hole 361, the additional hook insertion hole 361 configured to receive the additional hook 124, and wherein the rear cover coupling portion 360 and the additional rear cover coupling portion 360 are on an edge of the base plate 330.

The chassis 300 may further include the connecting rib 370 that connects the rear cover coupling portion 360 and the additional rear cover coupling portion 360.

The front chassis 320 may include the protruding rib 321 that protrudes, in an outward direction of the rear chassis 310, from the edge of the rear chassis 310, the front protrusion 322 that protrudes forward from one end of the protruding rib 321, and the rear protrusion 323 that protrudes rearward from the one end of the protruding rib 321.

The rear chassis 310 may include the chassis plate 311 in which the base plate 330 is disposed, and the chassis bent portion 312 that extends forward from the edge of the chassis plate 311. The protruding rib 321 may protrude, in a direction intersecting an extension direction of the chassis bent portion 312, from the edge of the chassis bent portion 312.

The chassis bent portion 312, the protruding rib 321, and the rear protrusion 323 may define the grooves (e.g., the first groove portion 320a, the second groove portion 320b, and the third groove portion 320c) that is open rearward.

The display apparatus 100 may further include the rear cover 120 that covers the rear side of the chassis 300. The rear cover 120 may include the first through-hole 122 and the second through-hole 123 that is configured to receive at least a portion of the stand 200.

The chassis 300 may comprise resin.

The display apparatus 100 according to an embodiment is configured to be detachably coupled to the stand 200. The display apparatus 100 includes the display panel 110, and the chassis 300 provided to support the display panel 110. The chassis 300 includes the rear chassis 310 provided behind the display panel 110, the front chassis 320 provided to cover the edge of the display panel 110 on the front side of the rear chassis 310, the base plate 330 provided on the inner side of the rear chassis 310, and formed integrally with the rear chassis 310 and the front chassis 320, and the beads (e.g., the first bead 341 and the second bead 342) provided to protrude rearward from the base plate 330 and provided to extend in the up and down direction. The first insertion hole 341b and the second insertion hole 342b is formed at the lower end of the beads (e.g., the first bead 341 and the second bead 342) to allow at least a portion of the stand 200 to be inserted thereinto.

The beads (e.g., the first bead 341 and the second bead 342) may be the first bead 341. The chassis 300 may further include the second bead 342 provided to protrude rearward from the base plate 330, provided to extend in the up and down direction, and spaced apart from the first bead 341 with respect to the direction D2 intersecting the direction in which the first bead 341 extends.

The chassis 300 may further include the third bead 350 provided to protrude rearward from the base plate 330, and provided to extend in the one direction to cross the first bead 341 and the second bead 342.

The display apparatus 100 may further include the rear cover 120 provided to cover the rear side of the chassis 300. The rear cover 120 may include the first through-hole 122 and the second through-hole 123 provided at a position corresponding to the first insertion hole 341b and the second insertion hole 342b to allow at least a portion of the stand 200 to be inserted thereinto.

The rear cover 120 may include the rear cover body 121, and the hook 124 provided on the edge of the rear cover body 121. The chassis 300 may further include the rear cover coupling portion 360 including the hook insertion hole 361 provided at a position corresponding to the hook 124 and provided to allow the hook 124 to be inserted thereinto. The rear cover coupling portion 360 may be formed by being recessed in the front surface of the base plate 330 so as to protrude rearward from the base plate 330.

As is apparent from the above description, a chassis may be formed by injection molding using a resin material. With the configuration, a manufacturing cost and material cost of a display apparatus may be relatively reduced.

Further, a chassis may include a plurality of beads protruding from a rear chassis, and thus a rigidity of the chassis may be reinforced. With the configuration, a display may be prevented from being bent when a stand is coupled to the display or when an external load is applied to the display.

Additional aspects of the present disclosure may be understood from the above description, or may be learned by practice of the present disclosure.

While non-limiting example embodiments of the present disclosure have been particularly described above with reference to the accompanying drawings, it should be understood by those of skilled in the art that various changes in form and details may be made without departing from the spirit and scope of the present disclosure.

What is claimed is:

1. A display apparatus configured to be detachably coupled to a stand, the display apparatus comprising:
a display panel; and
a chassis configured to support the display panel,
wherein the chassis comprises:
a rear chassis behind the display panel;
a front chassis covering an edge of the display panel on a front side of the rear chassis;
a base plate on an inner side of the rear chassis; and
a first bead recessed in a front surface of the base plate so as to protrude rearward from the base plate,
wherein the first bead comprises:
a first stand coupling portion including a first insertion hole, the first insertion hole configured to receive at least a portion of the stand in a first direction; and
a first extension portion that extends in the first direction from the first stand coupling portion.

2. The display apparatus of claim 1, wherein
a depth at which the first stand coupling portion is recessed in the front surface of the base plate is greater than a depth at which the first extension portion is recessed in the front surface of the base plate.

3. The display apparatus of claim 1, wherein
a width of the first stand coupling portion in a second direction intersecting the first direction is greater than a width of the first extension portion in the second direction.

4. The display apparatus of claim 1, wherein
the chassis further comprises a second bead recessed in the front surface of the base plate so as to protrude rearward from the base plate, wherein the second bead extends in a second direction intersecting the first direction.

5. The display apparatus of claim 1, wherein
the first insertion hole is open downward and configured to upwardly receive at least the portion of the stand,
wherein the first extension portion extends upward from the first stand coupling portion.

6. The display apparatus of claim 1, further comprising:
a rear cover covering a rear side of the chassis,
wherein the rear cover comprises:
a rear cover body; and
a hook on an edge of the rear cover body,
wherein the chassis further comprises a rear cover coupling portion comprising a hook insertion hole, the hook insertion hole configured to receive the hook.

7. The display apparatus of claim 6, wherein
the rear cover coupling portion is recessed in the front surface of the base plate so as to protrude rearward from the base plate.

8. The display apparatus of claim 6, wherein
the hook protrudes from the edge of the rear cover body toward an inside of the rear cover body,
wherein the hook insertion hole is open toward an outside of the base plate.

9. The display apparatus of claim 6, wherein
the rear cover further comprises an additional hook on the edge of the rear cover body,
the chassis further comprises an additional rear cover coupling portion comprising an additional hook insertion hole, the additional hook insertion hole configured to receive the additional hook, and
wherein the rear cover coupling portion and the additional rear cover coupling portion are on an edge of the base plate.

10. The display apparatus of claim 9, wherein
the chassis further comprises a connecting rib that connects the rear cover coupling portion and the additional rear cover coupling portion .

11. The display apparatus of claim 1, wherein
the front chassis comprises:
a protruding rib that protrudes, in an outward direction of the rear chassis, from an edge of the rear chassis;
a front protrusion that protrudes forward from one end of the protruding rib; and
a rear protrusion that protrudes rearward from the one end of the protruding rib.

12. The display apparatus of claim 11, wherein
the rear chassis comprises:
a chassis plate in which the base plate is disposed; and
a chassis bent portion that extends forward from an edge of the chassis plate,
wherein the protruding rib protrudes, in a direction intersecting an extension direction of the chassis bent portion, from an edge of the chassis bent portion.

13. The display apparatus of claim 12, wherein
the chassis bent portion, the protruding rib, and the rear protrusion define a groove that is open rearward.

14. The display apparatus of claim 13, further comprising:
a rear cover that covers a rear side of the chassis,
wherein the rear cover includes a through-hole that is configured to receive at least the portion of the stand.

15. The display apparatus of claim 1, wherein
the chassis comprises resin.

16. A display assembly comprising:
a stand; and
a display apparatus configured to be detachably coupled to the stand, the display apparatus comprising:
a display panel; and
a chassis configured to support the display panel,
wherein the chassis comprises:
a rear chassis behind the display panel;
a front chassis covering an edge of the display panel on a front side of the rear chassis;
a base plate on an inner side of the rear chassis; and
a first bead recessed in a front surface of the base plate so as to protrude rearward from the base plate,
wherein the first bead comprises:
a first stand coupling portion including a first insertion hole, the first insertion hole configured to receive at least a portion of the stand in a first direction; and
a first extension portion that extends in the first direction from the first stand coupling portion.

17. The display assembly of claim 16, wherein
a depth at which the first stand coupling portion is recessed in the front surface of the base plate is greater than a depth at which the first extension portion is recessed in the front surface of the base plate.

18. The display assembly of claim 16, wherein
a width of the first stand coupling portion in a second direction intersecting the first direction is greater than a width of the first extension portion in the second direction.

19. The display assembly of claim 16, wherein
the chassis further comprises a second bead recessed in the front surface of the base plate so as to protrude rearward from the base plate, wherein the second bead extends in a second direction intersecting the first direction.

20. A display apparatus configured to be detachably coupled to a stand, the display apparatus comprising:
a display panel; and
a chassis configured to support the display panel,
wherein the chassis comprises:
a rear chassis configured to be behind the display panel;
a front chassis configured to cover an edge of the display panel on a front side of the rear chassis;
a base plate configured to be on an inner side of the rear chassis; and
a first bead recessed in a front surface of the base plate so as to protrude rearward from the base plate,
wherein the first bead comprises:
a first stand coupling portion including a first insertion hole, the first insertion hole configured to receive at least a portion of the stand in a first direction; and
a first extension portion that extends in the first direction from the first stand coupling portion.
